(19) United States
(12) Patent Application Publication
(10) Pub. No.: US 2009/0241155 A1
(43) Pub. Date: Sep. 24, 2009

(54) Method and Apparatus to Facilitate Automatically Forming an Aggregation of Multiple Different Renderable Content Items

(75) Inventors: Nitya Narasimhan, Lake Zurich, IL (US); Tzvetan T. Horozov, Hoffman Estates, IL (US); Danesh S. Irani, Atlanta, GA (US); Swapnil E. Mhatre, Atlanta, GA (US); Clayton W. Shepard, Albuquerque, NM (US); Venugopal Vasudevan, Palatine, IL (US); Joseph W. Wodka, Hoffman Estates, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/050,295

(22) Filed: Mar. 18, 2008

(51) Int. Cl. H04N 7/173

(52) U.S. Cl. 725/112

(57) ABSTRACT

A network element (400) can receive (101) (from an end user (404) and via a data network (403)) a message as regards an aggregation of multiple different renderable content items. By one approach this message comprises, at least in part, selection criteria as have been selected by the end user. This network element can then automatically use (102) this selection criteria to select a plurality of specific renderable content items from amongst a plurality of candidate different renderable content items. These teachings will then support automatically combining (103) the plurality of specific renderable content items to form the requested aggregation of multiple different renderable content items.

### RELATED APPLICATIONS

This invention relates generally to a co-owned application entitled METHOD AND APPARATUS REGARDING RECEIPT OF AUDIO-VISUAL CONTENT INFORMATION AND USE OF SUCH INFORMATION TO AUTOMATICALLY INFER A RELATIVE POPULARITY OF THAT CONTENT as was filed on Dec. 28, 2007 bearing U.S. patent application Ser. No. 11/965,843 and bearing attorney's docket number CML06199 (7303/91181), the entire contents of which is fully incorporated herein by this reference.

### TECHNICAL FIELD

This invention relates generally to renderable digital content and more particularly to audio-visual content.

### BACKGROUND AUDIO

Renderable content of various kinds are known in the art. This includes both visual-only and audio-visual content. Examples in this regard include televised content as provided via any of a variety of carrier mechanisms including, for example, free space broadcasting via nationally licensed television broadcasting channels, cable-based delivery, satellite-based delivery, and Intemet-based delivery. “Renderable” in this context refers to an ability to render such content into a user perceivable form upon reception and/or during another time of desired playback. This can comprise, for example, rendering the content into visually perceivable images that are synchronized with audibly perceivable corresponding sounds.

Regardless of whether such content is, in the first instance of being televised, a pre-recorded offering or a live presentation, the present state of the art also includes the ability to record such content for later playback/rendering. This capability, however, coupled as well with an ever-growing number of content sources, channels, and content items, presents the end user with more content than can be reasonably consumed. As a result, end users often experience the disappointment of learning, too late, that they have missed a televised broadcast worth seeing. The ability to record such content for later viewing sometimes addresses this problem but often simply adds to the quantity of content that the end user cannot possibly find the time to watch.

At present, such end users must rely upon some selection mechanism (such as ratings guides, published reviews, pertinent blogs, or input from their acquaintances) to inform their decisions regarding what to watch and what to ignore. Even this approach, however, can leave a given end user with too much content to consume. Numerous other related problems of the same general ilk also exist for some end users. The combination of greatly proliferating content with difficulty in identifying content of likely interest with insufficient time to consume selected content leads in numerous ways to various forms of end user dissatisfaction.

### BRIEF DESCRIPTION OF THE DRAWINGS

The above needs are at least partially met through provision of the method and apparatus to facilitate automatically forming an aggregation of multiple different renderable content items described in the following detailed description, particularly when studied in conjunction with the drawings, wherein:

FIG. 1 comprises a flow diagram as configured in accordance with various embodiments of the invention;

FIG. 2 comprises a schematic diagram as configured in accordance with various embodiments of the invention;

FIG. 3 comprises a schematic diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network element can receive (from an end user and via a data network) a message as regards an aggregation of multiple different renderable content items. By one approach this message comprises, at least in part, selection criteria as have been selected by the end user. This network element can then automatically use this selection criteria to select a plurality of specific renderable content items from amongst a plurality of candidate different renderable content items. These teachings will then support automatically combining the plurality of specific renderable content items to form the requested aggregation of multiple different renderable content items.

These teachings will support a wide variety of selection criteria. Examples include, but are not limited to, context information regarding a consuming context in which the aggregation is to be rendered for an intended consumer, information regarding entities that contributed any of the multiple different renderable content items, an intended application purpose regarding consumption of the aggregation, temporally-based selection criteria, one or more content-identifying keywords, and so forth. Other examples are possible.

These teachings will also support storing information as corresponds to the aggregation. This information might comprise, for example, the aggregation itself, the selection criteria used to select the plurality of specific renderable content items, and/or other metadata as may correspond to the content. These teachings will also further support delivering the aggregation to the end user (and/or to other interested or potentially interested parties).

So configured, these teachings will support the forming of an aggregation of renderable content that is drawn, for example, from a single shared original composite renderable content item. By this approach, a given item of content can be reduced, for example, to a series of highlights (as per the selection criteria of the end user) to yield an aggregation that can be consumed in less time while nevertheless satisfying the end user's needs for that particular content. As another example in these regards, these teachings will support forming an aggregation of content items that are from differing original source content but that nevertheless share a same original source event. For example, the aggregation can comprise a brief series of highlights of a high school football game as drawn from various videos of that game as taken by various parties at various locations.

These and numerous other opportunities become readily and economically available via these teachings. It will be further appreciated that these teachings are readily employed with existing video repositories but will also well accommodate various future possibilities in this regard. Those skilled in the art will recognize and appreciate that the use of a highly flexible section criteria mechanism offers great individualized power and control to the end user and facilitates making useable sense of an otherwise overwhelming quantity of content.

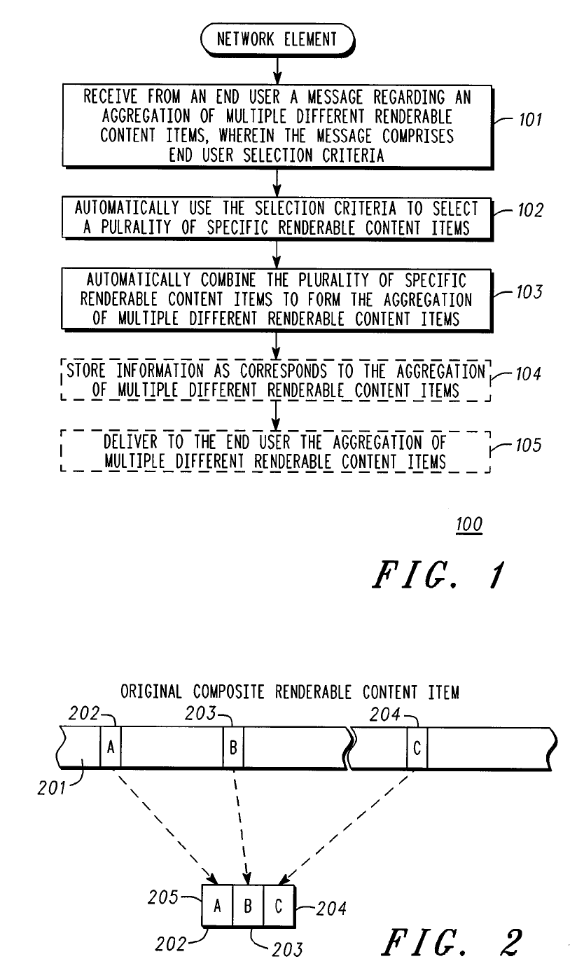

These and other benefits may become clearer upon making a thorough review and study of the following detailed description. Referring now to the drawings, and in particular to FIG. 1, an illustrative process that is compatible with many of these teachings will now be presented.

This process 100 can be carried out by a network element of choice. By one approach, for example, a server of choice can serve as the network element. Other architectural options exist as well as will be well understood by those skilled in the art and other suitable platforms are likely to be developed going forward. Further description regarding this network element appears below where appropriate.

This process 100 provides for receiving 101, from an end user and via a data network, a message as regards an aggregation of multiple different renderable content items (as but one example in this regard, this message can comprise a request for such an aggregation). As used herein, it will be understand that this reference to renderable content items can refer to audio-visual content of various kinds (where the audio and visual portions are synchronized one to the other), visual-only content, as well as audio-only content. For the sake of simplicity and for the purposes of example and not by way of limitation, the remainder of this description will presume the renderable content items to comprise televised content (that is, user perceivable content that has been televised via an appropriate carrier mechanism).

The precise nature and form of these different renderable content items can vary from one application setting to another. For example, by one approach, these renderable content items can comprise different portions of a shared original composite renderable content item. To illustrate, and referring momentarily to FIG. 2, three different renderable content items denoted as A, B, and C (202, 203, and 204, respectively) are shown to comprise, in this example, different portions of an original composite renderable content item 201. This original composite renderable content item 201 itself might comprise, for example, a single complete televised program (such as an hour long drama, a three hour football event, a ninety minute concert, a one hour news program, and so forth, to note only a few examples in this regard).

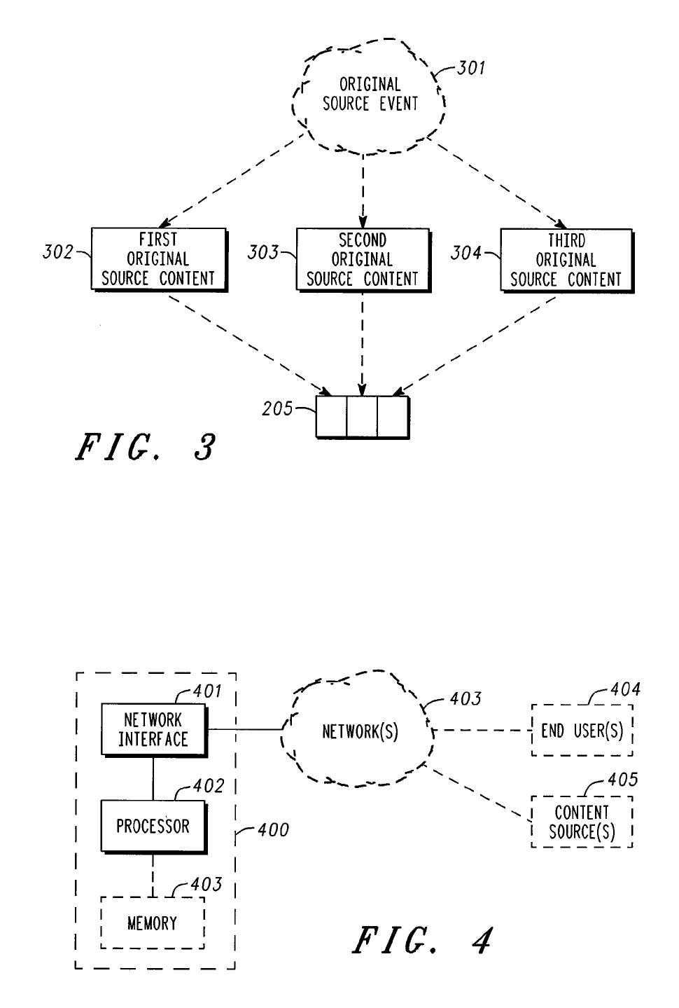

As another example, and by another approach, these renderable content items can stem from differing original source content that nevertheless share a same original source event. To illustrate, and referring now momentarily to FIG. 3, the renderable content items can relate to three different original source content items 302, 303, and 304. The latter, in turn, all represent content drawn from an original source event 301. This original source event 301 might comprise, for example, a sporting event such as a football game. The first original source content 302 might in turn comprise a television network broadcast of that football game while the second and third original source content items 303 and 304 might comprise portions of that football game as were recorded by private individuals using, respectively, a personal camcorder and a cellular telephone having video recording capabilities.

Numerous other possibilities in this regard are of course possible. By one approach, these various multiple different renderable content items to which the received message refers can reside at the network element itself and/or can be stored or otherwise available elsewhere to the network element and/or to another relevant processing platform as is operably coupled to the network element. By one approach, a tuner farm may serve to source at least some of this content. By another approach, a public forum such as You Tube may comprise the source for at least some of the content.

These teachings will accommodate the use of renderable content items that are, in and of themselves, complete. For example, each such renderable content item can comprise a complete program, sporting event, news offering, or the like. These teachings will also accommodate, however, the use of renderable content items that only themselves comprise a portion of a larger work. Such clips can be formed, identified, tagged, characterized, and/or otherwise stored and recalled in any of a variety of ways. A number of approaches in this regard are set forth in the patent application entitled METHOD AND APPARATUS REGARDING RECEIPT OF AUDIO-VISUAL CONTENT INFORMATION AND USE OF SUCH INFORMATION TO AUTOMATICALLY INFER A RELATIVE POPULARITY OF THAT CONTENT as referenced above.

Referring again to FIG. 1, by one approach, this received message can comprise, at least in part, selection criteria as have been selected by the end user. This selection criteria can comprise, as desired, criteria that the end user has specified from a menu of pre-selected and pre-defined criteria and/or freely specifiable criteria as might be specified by the use of one or more free text entry opportunities (as employed, for example, when providing search criteria to a Web browser). These teachings will also accommodate the use of logical operators to further specify particular logical relationships or requirements as regards one or more criterion. Examples of possibly useful logical operators include, but are not limited to, AND, OR, NOR, BUT NOT, and so forth. Such techniques are generally well known in the art and require no further elaboration here.

The specific nature of the selection criteria can vary with the needs and/or opportunities as characterize a given application setting and can also vary, if desired, with the individual end user.

By one approach, this selection criteria can comprise, at least in part, personal information regarding an intended consumer of the aggregation of multiple different renderable content items. This intended consumer might be the end user themselves or might be another party such as a co-worker, a supervisor, an employee, a child, a parent, and so forth. As one simple illustrative example in this regard, such a selection criterion might comprise an age of the intended consumer of the material. When, for example, the age of the intended consumer is specified as being under thirteen years of age, the selection criterion can be understood as specifying age-appropriate material that excludes material inappropriate for a young minor.

As another example, this selection criteria can comprise, at least in part, context information regarding a consuming context in which the aggregation of multiple different renderable content items is to be rendered for an intended consumer. Examples of possibly relevant consuming contexts include, but are not limited to, a consuming environment (such as a home viewing environment, an office viewing environment, a public viewing environment, an automobile viewing environment, and so forth) or a rendering modality context (such as a small display screen, a large display screen, a high definition display screen, a surround sound speaker system, a monaural speaker system, and so forth).

As another example, this selection criteria can comprise, at least in part, information regarding entities that contributed any of the multiple different renderable content items. This might comprise, for example, identification of a particular television network or Web video resource. This might also comprise, for example, identification of a particular individual or organization that captured the original content or who contributed or identified, for example, the desired target video clip(s). By way of illustration, such a selection criterion might comprise “Akbar Smith” (i.e., an individual's name) or “Chicago Football Club.”

As another example, this selection criteria can comprise, at least in part, an intended application purpose regarding consumption of the aggregation of multiple different renderable content items. This might comprise, for example specifying an application purpose such as “catching up,” “historical summary,” or the like. Such a selection criterion can permit an end user to specify, for example, that the intended application purpose of the aggregation is to quickly catch up on the key plays as have already occurred in a presently televised sporting event to then permit that end user to watch a remaining portion of that sporting event with a good working knowledge of the action so far.

As yet another example, this selection criteria can comprise, at least in part, temporally-based selection criteria. This might comprise, for example, specifying a maximum (or a minimum) amount of time for the aggregation of multiple different renderable content items. This might also comprise, if desired, specifying a maximum amount of time for any single individual item of renderable content. This can also comprise, if desired, specifying a particular currency, or dated, item of renderable content. For example, this selection criterion could specify that only content items within the past five days should be used.

As yet another example, this selection criteria can comprise, at least in part, one or more content-identifying keywords. Such a keyword can be limited to a specific grammatical element (such as only nouns, verbs, or the like) or can be unlimited in this regard. Such a selection criteria can serve to identify the specific substantive content that is of interest to the end user.

As yet another example, this selection criteria can comprise, at least in part, an identity of another end user. Such a designation (for example, a specific name) may be particularly useful in an application setting where one or more profiles exist that correlate such identification information with one or more preferences of that particular individual. Such preferences might further inform the aggregation process by providing information regarding substantive content preferences, temporally-based viewing preferences, viewing modality limitations, and so forth.

As yet another example, this selection criteria can comprise, at least in part, a characterization of content scope. As applied to a popular television program, for example, this could serve to indicate whether a summary is being sought for a single episode, an entire season of episodes, or the entire life of the program over a plurality of seasons.

As yet another example in these regards, this selection criteria can comprise, at least in part, a requirement regarding a relative level of popularity as individually corresponds to the renderable content items. Such a selection criterion can be useful, for example, to specify whether video clips as have some form of viewer ratings (such as one finds at a service such as You Tube) are to have at least some minimal popularity rating to be considered for inclusion within the aggregation of multiple different renderable content items.

And as yet another example in these regards, this selection criteria can comprise, at least in part, at least one filter tag to, for example, either ALLOW or DENY specific tags. Those skilled in the art will understand that, as used herein, tags comprise a kind of metadata that is usually appended to a given item of content by members of a user population. These tags essentially serve as a way to permit such persons to characterize the content of the item using pre-specified or free form words or expressions. As one simple example in this regard, this selection criteria could specify denying the use of any content item bearing a tag such as “profanity,” “boring,” “poor lighting,” or the like.

This process 100 then provides for automatically using 102 the selection criteria to select a plurality of specific renderable content items from amongst a plurality of candidate different renderable content items. These candidate content items can all reside within a shared repository if desired (such as You Tube or another social site having such content) or can be spread over a plurality of different (possibly unrelated) repositories. These candidates, of course, may cover essentially any subject using essentially any modality of presentation. The selection of the specific renderable content items, however, is guided, at least in part, by reference to the aforementioned selection criteria.

These teachings will accommodate taking selection criteria other than that which has been provided by the end user into account to supplement the latter. For example, the aggregation agent may offer a tiered service by which a given end user has access to a smaller or larger number of candidate items as a function, for example, of the amount of their monthly subscription fee. Other possibilities in this regard exist as well.

This process 100 then provides for automatically combining 103 this plurality of specific renderable content items to form the desired aggregation of multiple different renderable content items. As used herein, the expression “aggregation” will be understood to refer to a plurality of individual discrete content items that are combined into an integral whole. By one approach, this can comprise concatenating the individual discrete content items one to the other to form the aggregated whole. By another approach, in combination with the foregoing or in lieu thereof, split-screen or other techniques for presenting multiple individual content items together on a same display simultaneously with one another can be employed to provide the desired aggregation.

Referring again to FIG. 2, as one illustrative example in this regard, three individual discrete content items 202, 203, and 204 have been drawn from an original composite renderable content item 201 as meeting the selection criteria of the end user. For example, the original composite renderable content item 201 might comprise a football game and the selection criteria might have identified this particular game and then further specified content that relates key plays by a particular player. In such an example, these three individual discrete content items 202, 203, and 204 would comprise audio-visual content that presents the key plays of this particular player in this particular game. Pursuant to the aforementioned aggregation functionality these three individual discrete content items 202, 203, and 204 are combined (via, in this example, concatenation in a temporally sequential manner) to achieve the desired aggregation 205.

As another example in this regard, and referring now again to FIG. 3, the resultant aggregation 205 can instead be formed through concatenation of audio-visual content as has been drawn from three separate, discrete content sources 302, 303, and 304. For the sake of illustration, these discrete original content sources 302, 303, and 304 may each contain audio-visual content as pertains to an original source event 301 comprising, again, a sporting event. In this example, the end user's selection criteria has specified this particular event and then further specified content that relates to the one and only goal as was scored in this event. The original content sources 302, 303, and 304 can each comprise content, at least in part, that provides a view of that goal (albeit from the different perspectives of the various sources, which might comprise, for example, the camcorder results of various event attendees).

By one approach, this aggregation can comprise a simplistic connecting of each individual portion, one to the other. By another approach, automated editing and scene transition techniques can be employed as desired. This might include, for example, dissolves, fading in and fading out, fly-ins and fly-outs, and so forth to transition between such segments. Such an aggregation can also be further embellished, if desired, in other ways. For example, if desired, same language or foreign language subtitling can be provided (based either upon such content as may be available in the original content or via, for example, an automated speech recognition process that recognizes speech in the original content and renders that speech as textual subtitles).

If desired, this process 100 can also accommodate storing 104 information as corresponds to this aggregation of multiple different renderable content items. Such information can comprise, for example, the aggregation itself (either in an original form or, if desired, some compressed version thereof). Such information can also comprise, if desired, part or all of the selection criteria as was used to select the plurality of specific renderable content items. When storing the selection criteria, such information can be stored, for example, as metadata in conjunction with the aggregation of multiple different renderable content items (though these teachings will also accommodate storing only the selection criteria and not the aggregation content itself).

By storing the aggregation content itself, the end user (or another entity) can later recall exactly that same content if desired. By storing the selection criteria, however, it becomes possible to provide a dynamically changing resultant aggregation. For example, by recalling that same selection criteria one week after consuming the original aggregation, a different aggregation may be provided based upon a different present selection of candidate material.

This process 100 will also optionally accommodate delivering 105 the resultant aggregation of multiple different renderable content items to the end user. Those skilled in the art will recognize and appreciate that such a step can be carried out in any of a variety of ways. By one approach, for example, this can comprise providing the aggregated content as streaming content to be viewed essentially in real time. By another approach, however, this can provide transferring the aggregated content to the end user as a file which can then be consumed later at the convenience of the end user.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided.

In this illustrative example, the aforementioned network element 400 can comprise a network interface 401 that operably couples to a processor 402. If desired, this process 402 may also operably couple to a memory 403. The network interface 401 can be configured to receive from an end user (404), via an intervening data network (or networks) 403, the aforementioned message as regards an aggregation of multiple different renderable content items, wherein the message comprises, at least part, selection criteria as have been selected by the end user (404). Those skilled in the art will recognize that this network interface 401 can vary with the needs, opportunities, and protocols as characterize the network(s) 403 to which the network interface 401 couples. By one approach, for example, this network interface 401 can comprise an Internet interface of choice.

Those skilled in the art will recognize and appreciate that such a processor 402 can comprise a fixed-purpose hard-wired platform or can comprise a partially or wholly programmable platform. All of these architectural options are well known and understood in the art and require no further description here. This processor 402 can be configured and arranged (via, for example, appropriate programming as will be well understood by those skilled in the art) to carry out one or more of the steps, actions, and/or functions as are set forth herein. This can include, for example, automatically using the received selection criteria to select a plurality of specific renderable content items from amongst a plurality of candidate different renderable content items (as may be available locally in the aforementioned memory 403 and/or from one or more remote content sources 405 as may be accessible via the aforementioned network(s) 403) and then automatically combining that plurality of specific renderable content items to form the desired aggregation of multiple different renderable content items.

Those skilled in the art will recognize and understand that such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, these teachings provide for an efficient, economical, and powerful mechanism to provide for the automatic creation of deliverables such as audio-visual clips that comprise an aggregation of a variety of discrete though substantively relevant content items. These teachings can be readily applied in conjunction with any of a wide variety of video and audio formats and content comprising essentially any substantive content of potential interest. These teachings are readily scaled to work in conjunction with essentially an unlimited number of candidate content items and will also easily scale to accommodate essentially unlimited selection criteria. These teachings can be applied to combine only portions of source materials or can also serve to aggregate, in total, two or more source items.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network element:
receiving from an end user, via a data network, a message as regards an aggregation of multiple different renderable content items, wherein the message comprises, at least in part, selection criteria as have been selected by the end user;
automatically using the selection criteria to select a plurality of specific renderable content items from amongst a plurality of candidate different renderable content items;
automatically combining the plurality of specific renderable content items to form the aggregation of multiple different renderable content items.

2. The method of claim 1 wherein the message comprises a request for the aggregation of multiple different renderable content items.

3. The method of claim 2 further comprising:
delivering to the end user the aggregation of multiple different renderable content items.

4. The method of claim 2 further comprising:
storing information as corresponds to the aggregation of multiple different renderable content items.

5. The method of claim 4 wherein the information comprises the aggregation of multiple different renderable content items.

6. The method of claim 5 wherein storing information as corresponds to the aggregation of multiple different renderable content items further comprises storing at least some of the selection criteria as metadata in conjunction with the aggregation of multiple different renderable content items.

7. The method of claim 4 wherein the information comprises the selection criteria used to select the plurality of specific renderable content items.

8. The method of claim 1 wherein the selection criteria comprise, at least in part, personal information regarding an intended consumer of the aggregation of multiple different renderable content items.

9. The method of claim 1 wherein the selection criteria comprise, at least in part, context information regarding a consuming context in which the aggregation of multiple different renderable content items is to be rendered for an intended consumer.

10. The method of claim 1 wherein the selection criteria comprise, at least in part, information regarding entities that contributed any of the multiple different renderable content items.

11. The method of claim 1 wherein the selection criteria comprise, at least in part, an intended application purpose regarding consumption of the aggregation of multiple different renderable content items.

12. The method of claim 1 wherein the selection criteria comprise, at least in part, temporally-based selection criteria.

13. The method of claim 1 wherein the selection criteria comprise, at least in part, at least one content-identifying keyword.

14. The method of claim 1 wherein the selection criteria comprise, at least in part, at least one of:
an identity of another end user;
a characterization of content scope;
a requirement regarding a relative level of popularity as individually corresponds to the renderable content items;
at least one filter tag to either ALLOW or DENY specific tags.

15. The method of claim 1 wherein the aggregation of multiple different renderable content items comprises different portions of a shared original composite renderable content item.

16. The method of claim 1 wherein at least some of the multiple different renderable content items are from differing original source content but share a same original source event.

17. A network element comprising:
a network interface configured and arranged to receive from an end user, via a data network, a message as regards an aggregation of multiple different renderable content items, wherein the message comprises, at least in part, selection criteria as have been selected by the end user;
a processor operably coupled to the network interface to receive the message and to responsively:
automatically use the selection criteria to select a plurality of specific renderable content items from amongst a plurality of candidate different renderable content items;
automatically combine the plurality of specific renderable content items to form the aggregation of multiple different renderable content items.

18. The network element of claim 17 wherein the processor is further configured and arranged to deliver to the end user the aggregation of multiple different renderable content items.

19. The network element of claim 17 wherein the processor is further configured and arranged to store information as corresponds to the aggregation of multiple different renderable content items.

20. The network element of claim 17 wherein the selection criteria comprise, at least in part, at least two of:
personal information regarding an intended consumer of the aggregation of multiple different renderable content items;
content information regarding a consuming context in which the aggregation of multiple different renderable content items is to be rendered for an intended consumer;
information regarding entities that contributed any of the multiple different renderable content items;
an intended application purpose regarding consumption of the aggregation of multiple different renderable content items;
temporally-based selection criteria;
at least one content-identifying keyword.
